(19) United States
(12) Patent Application Publication
(10) Pub. No.: US 2020/0291187 A1
(43) Pub. Date: Sep. 17, 2020

(54) CURABLE SILICONE COMPOSITION WITH REDUCED MOLD FOULING

(71) Applicant: Dow Silicones Corporation, Midland, MI (US)

(72) Inventors: Martijn A. Beukema, Bruxelles (BE); Stanton Dent, Midland, MI (US); Pierre Descamps, Rixensart (BE); Stuart Leadley, Ck (IE); Joel McDonald, Midland, MI (US); Kevin van Tiggelen, Seneffe (BE); Michelle Cummings, Midland, MI (US); Serge Creutz, Liege (BE); Francois de Buyl, Seneffe (BE)

(73) Assignee: Dow Silicones Corporation, Midland, MI (US)

(21) Appl. No.: 16/611,918

(22) PCT Filed: May 17, 2018
(86) PCT No.: PCT/US2018/033123

§ 371 Date: Nov. 8, 2019

Related U.S. Application Data
(60) Provisional application No. 62/514,092, filed on Jun. 2, 2017.

(51) Int. Cl. C08G 77/20; C08G 77/06; C09D 183/06; B29C 45/00

(52) U.S. Cl. CPC C08G 77/20; C08G 77/06; B29K 2083/00; B29C 45/0001; C09D 183/06

(57) ABSTRACT

A curable silicone composition comprising (A) an alkenyl-containing organopolysiloxane comprising (A-1) a dialkylpolysiloxane that has an average of at least two alkenyl groups in each molecule), and (A-2) an alkenyl-containing, resin-form organopolysiloxane that comprises the SiO_{4/2} unit, R¹₂R²SiO_{1/2} unit, and R¹₃SiO_{1/2} unit; (B) an organopolysiloxane that has an average of at least three silicon-bonded hydrogen atoms in each molecule, wherein component (B) is an organopolysiloxane comprising (B-1) an organopolysiloxane that contains at least 0.7 mass % silicon-bonded hydrogen and that comprises SiO_{4/2} units and HR³₂SiO_{1/2} units in a ratio ranging from 1.50 to 2.50 moles of HR³₂SiO_{1/2} units per 1 mole of SiO_{4/2} units, at 50 to 100 mass % of component (B), and (B-2) a straight-chain organopolysiloxane that contains at least 0.3 mass % silicon-bonded hydrogen, at 0 to 50 mass % of component (B); and (C) a hydrosilylation reaction catalyst.

### CROSS-REFERENCE TO RELATED APPLICATIONS

None.

### FIELD OF THE INVENTION

The present invention relates to a curable silicone composition that provides a flexible and highly transparent cured silicone material and that reduces mold fouling during molding process. The present invention further relates to the cured silicone composition formed by thermosetting the curable silicone composition. The present invention still further relates to a method of curing a silicone composition comprising thermosetting the curable silicone composition in a mold.

### BACKGROUND OF THE INVENTION

Curable silicone compositions that contain a resin-form organopolysiloxane and that provide a highly transparent cured silicone material are known. For example, JP 2005-042099 A (Equivalent to US 2005-0006794 A1) describes a silicone rubber composition comprising an organopolysiloxane that has at least two aliphatically unsaturated bonds in each molecule; an organopolysiloxane having a resin structure and comprising the SiO₂ unit, an R₃SiO_{0.5} unit having 2-3 vinyl groups, and an R₃SiO_{0.5} unit having 0-1 vinyl group, wherein the non-vinyl R in these formulas is monovalent hydrocarbyl that does not contain an aliphatically unsaturated bond, e.g., methyl and so forth; an organohydrogenpolysiloxane that has at least two silicon-bonded hydrogen atoms in each molecule; and a platinum group metal-based catalyst. In the following, the SiO₂ unit is referred to as the Q unit and the R₃SiO_{0.5} unit is referred to as the M unit.

The polyorganosiloxane composition described in JP 2006-335857 A provides a transparent cured material and comprises a straight-chain polyorganosiloxane containing silicon-bonded alkenyl and having a viscosity at 23° C. of 10 to 10,000 mm²/s; a branched polyorganosiloxane comprising the Q unit, an M unit having one vinyl group, and an M unit that does not contain an aliphatically unsaturated bond; a polyalkylhydrogensiloxane comprising the Q unit, an M unit having one silicon-bonded hydrogen atom, and an M unit that does not contain silicon-bonded hydrogen; and a platinum group metal compound.

The curable silicone composition described in JP 2007-131694 A (equivalent to US2009-0118441 A1) comprises at least a diorganopolysiloxane that has at least two alkenyl groups in each molecule; at least two resin-form organopolysiloxanes that have different mass-average molecular weights, each comprising the Q unit, an M unit having one vinyl group, and an M unit that does not contain an aliphatically unsaturated bond; an organopolysiloxane that has at least two silicon-bonded hydrogen atoms in each molecule; and a hydrosilylation reaction catalyst.

JP 2006-328102 A (equivalent to US2006-0264583 A1) describes a silicone polymer composition for lens molding, that characteristically provides a colorless and transparent cured material and that comprises as its essential components an organopolysiloxane that has at least two aliphatically unsaturated bonds in each molecule and a viscosity of at least 100 mPa·s at 25° C., an organohydrogenpolysiloxane that has at least three H(CH₃)₂SiO_{1/2} units in each molecule, and a platinum group metal catalyst.

U.S. Pat. No. 8,859,693 describes a curable silicone composition for optical devices comprising (A) 100 mass parts of an alkenyl containing organopolysiloxane comprising (A-1) a dialkylpolysiloxane that has an average of at least two alkenyl groups in each molecule and a viscosity at 25° C. of at least 1,000 mPa·s to not more than 50,000 mPa·s, at from 50 mass % to not more than 80 mass % of component (A), and (A-2) an alkenyl-containing, resin-form organopolysiloxane that comprises the SiO_{4/2} unit, R¹₂R²SiO_{1/2} unit, and R¹₃SiO_{1/2} unit wherein R¹ is C₁₋₁₀ alkyl and R² is alkenyl and that contains the alkenyl group in the range from at least 0.5 mass % to less than 3.5 mass %, at from 20 mass % to not more than 50 mass % of component (A); (B) an organopolysiloxane that has an average of at least three silicon-bonded hydrogen atoms in each molecule wherein the silicon-bonded groups other than the silicon-bonded hydrogen are C₁₋₁₀ alkyl, in an amount that provides 0.8 to 2 moles silicon-bonded hydrogen in this component per 1 mole of the total alkenyl in component (A); and (C) a hydrosilylation reaction catalyst in a catalytic quantity, and provides a highly transparent cured silicone material that characteristically has a hardness measured using the type A durometer specified in JIS K 6253 is in the range from at least 30 to not more than 80, the elongation as specified in JIS K 6251 is at least 50%, the parallel light transmittance at 25° C. measured in accordance with JIS K 7105 on a 6 mm optical path length is at least 90%, and the parallel light transmittance at 200° C. is a value that is at least 99% of the parallel light transmittance at 25° C.

However, these curable silicone compositions are prone to prematurely foul molds during the production process. During the molding process silicon-based deposits can build up on the mold. Over time, these silicone deposits can grow in size, and the molded part replicates the shape of these deposits which is undesirable in many cases. This process is known as mold fouling. Mold fouling is especially negative in optical applications where the imperfections in the molded article can interfere with light path, transmittance, and intensity, and the mold fouling is more pronounced in complex molds. Therefore, this premature fouling, or build-up of deposits, requires the interruption of the production process to clean the molds of these silicon-based deposits. This cleaning of the molds can shorten the useful life of the mold and increase production costs by decreasing production efficiency and increasing the frequency of mold replacement.

### BRIEF SUMMARY OF THE INVENTION

The present invention is directed to a curable silicone composition comprising
(A) 100 mass parts of an alkenyl-containing organopolysiloxane comprising (A-1) a dialkylpolysiloxane that has an average of at least two alkenyl groups in each molecule and a viscosity at 25° C. of 5000 to 1,000,000 mPas, at from 20 mass % to not more than 60 mass % of component (A), and (A-2) an alkenyl-containing, resin-form organopolysiloxane that comprises the SiO_{4/2} unit, R¹₂R²SiO_{1/2} unit, and R¹₃SiO_{1/2} unit wherein R¹ is C₁₋₁₀ alkyl and R² is alkenyl, and that contains the alkenyl group in the range from at least 1 mass % A to less than 3.5 mass %, at from 40 mass % to not more than 80 mass % of component (A);
(B) an organopolysiloxane that has an average of at least three silicon-bonded hydrogen atoms in each molecule wherein the silicon-bonded groups other than the silicon-bonded hydrogen are C₁₋₁₀ alkyl, in an amount that provides 1.2 to less than 2.2 moles silicon-bonded hydrogen in this component per 1 mole of the total alkenyl in component (A), wherein component (B) is an organopolysiloxane comprising (B-1) an organopolysiloxane that contains at least 0.7 mass % silicon-bonded hydrogen and that comprises SiO_{4/2} units and HR³₂SiO_{1/2} units in a ratio ranging from 1.50 to 2.50 moles of HR³₂SiO_{1/2} units per 1 mole of SiO_{4/2} units wherein R³ is C₁₋₁₀ alkyl, at 50 to 100 mass % of component (B), and (B-2) a straight-chain organopolysiloxane that contains at least 0.3 mass % silicon-bonded hydrogen wherein the silicon-bonded groups other than the silicon-bonded hydrogen are C₁₋₁₀ alkyl, at 0 to 50 mass % of component (B); and (C) a hydrosilylation reaction catalyst in a catalytic quantity.

The present invention is further directed to a method of forming a highly transparent cured silicone material, the method comprising the following steps: heating a curable silicone composition comprising (A) 100 mass parts of an alkenyl-containing organopolysiloxane comprising (A-1) a dialkylpolysiloxane that has an average of at least two alkenyl groups in each molecule and a viscosity at 25° C. of 5000 to 1,000,000 mPas, at from 20 mass % to not more than 60 mass % of component (A), and (A-2) an alkenyl-containing, resin-form organopolysiloxane that comprises the SiO_{4/2} unit, R¹₂R²SiO_{1/2} unit, and R¹₃SiO_{1/2} unit wherein R¹ is C₁₋₁₀ alkyl and R² is alkenyl, and that contains the alkenyl group in the range from at least 1 mass % to less than 3.5 mass %, at from 40 mass % to not more than 80 mass % of component (A); (B) an organopolysiloxane that has an average of at least three silicon-bonded hydrogen atoms in each molecule wherein the silicon-bonded groups other than the silicon-bonded hydrogen are C₁₋₁₀ alkyl, in an amount that provides 1.2 to less than 2.2 moles silicon-bonded hydrogen in this component per 1 mole of the total alkenyl in component (A),

wherein component (B) is an organopolysiloxane comprising (B-1) an organopolysiloxane that contains at least 0.7 mass % silicon-bonded hydrogen and that comprises SiO_{4/2} units and HR³₂SiO_{1/2} units in a ratio ranging from 1.50 to 2.50 moles of HR³₂SiO_{1/2} units per 1 mole of SiO_{4/2} units wherein R³ is C₁₋₁₀ alkyl, at 50 to 100 mass % of component (B), and (B-2) a straight-chain organopolysiloxane that contains at least 0.3 mass % silicon-bonded hydrogen wherein the silicon-bonded groups other than the silicon-bonded hydrogen are C₁₋₁₀ alkyl, at 0 to 50 mass % of component (B); and (C) a hydrosilylation reaction catalyst in a catalytic quantity at a temperature from 120 to 180° C.

The curable silicone composition and method of forming a highly transparent cured silicone material of the invention provide a flexible and highly transparent cured silicone material without prematurely fouling molds during repeated curing.

### DETAILED DESCRIPTION OF THE INVENTION

A curable silicone composition comprising
(A) 100 mass parts of an alkenyl-containing organopolysiloxane comprising
   (A-1) a dialkylpolysiloxane that has an average of at least two alkenyl groups in each molecule and a viscosity at 25° C. of 5000 to 1,000,000 mPas, at from 20 mass % to not more than 60 mass % of component (A), and
   (A-2) an alkenyl-containing, resin-form organopolysiloxane that comprises the SiO_{4/2} unit, R¹₂R²SiO_{1/2} unit, and R¹₃SiO_{1/2} unit wherein R¹ is C₁₋₁₀ alkyl and R² is alkenyl, and that contains the alkenyl group in the range from at least 1 mass % to less than 3.5 mass %, at from 40 mass % to not more than 80 mass % of component (A);
(B) an organopolysiloxane that has an average of at least three silicon-bonded hydrogen atoms in each molecule wherein the silicon-bonded groups other than the silicon-bonded hydrogen are C₁₋₁₀ alkyl, in an amount that provides 1.2 to less than 2.2 moles silicon-bonded hydrogen in this component per 1 mole of the total alkenyl in component (A), wherein component (B) is an organopolysiloxane comprising
   (B-1) an organopolysiloxane that contains at least 0.7 mass % silicon-bonded hydrogen and that comprises SiO_{4/2} units and HR³₂SiO_{1/2} units in a ratio ranging from 1.50 to 2.50 moles of HR³₂SiO_{1/2} units per 1 mole of SiO_{4/2} units wherein R³ is C₁₋₁₀ alkyl, at 50 to 100 mass % of component (B), and
   (B-2) a straight-chain organopolysiloxane that contains at least 0.3 mass % silicon-bonded hydrogen wherein the silicon-bonded groups other than the silicon-bonded hydrogen are C₁₋₁₀ alkyl, at 0 to 50 mass % of component (B); and
(C) a hydrosilylation reaction catalyst in a catalytic quantity.

A method of forming a highly transparent cured silicone material, the method comprising the following steps: heating a curable silicone composition comprising (A) 100 mass parts of an alkenyl-containing organopolysiloxane comprising
(A-1) a dialkylpolysiloxane that has an average of at least two alkenyl groups in each molecule and a viscosity at 25° C. of 5000 to 1,000,000 mPas, at from 20 mass % to not more than 60 mass % of component (A), and
(A-2) an alkenyl-containing, resin-form organopolysiloxane that comprises the SiO_{4/2} unit, R¹₂R²SiO_{1/2} unit, and R¹₃SiO_{1/2} unit wherein R¹ is C₁₋₁₀ alkyl and R² is alkenyl, and that contains the alkenyl group in the range from at least 1 mass % to less than 3.5 mass %, at from 40 mass % to not more than 80 mass % of component (A);
(B) an organopolysiloxane that has an average of at least three silicon-bonded hydrogen atoms in each molecule wherein the silicon-bonded groups other than the silicon-bonded hydrogen are C₁₋₁₀ alkyl, in an amount that provides 1.2 to less than 2.2 moles silicon-bonded hydrogen in this component per 1 mole of the total alkenyl in component (A), wherein component (B) is an organopolysiloxane comprising
   (B-1) an organopolysiloxane that contains at least 0.7 mass % silicon-bonded hydrogen and that comprises SiO_{4/2} units and HR³₂SiO_{1/2} units in a ratio ranging from 1.50 to 2.50 moles of HR³₂SiO_{1/2} units per 1 mole of SiO_{4/2} units wherein R³ is C₁₋₁₀ alkyl, at 50 to 100 mass % of component (B), and
   (B-2) a straight-chain organopolysiloxane that contains at least 0.3 mass % silicon-bonded hydrogen wherein the silicon-bonded groups other than the silicon-bonded hydrogen are C₁₋₁₀ alkyl, at 0 to 50 mass % of component (B); and
(C) a hydrosilylation reaction catalyst in a catalytic quantity at a temperature from 120 to 180° C.

The alkenyl-containing organopolysiloxane (A) comprises (A-1) a dialkylpolysiloxane that has an average of at least two alkenyl groups in each molecule and a viscosity at 25° C. of 5000 to 1,000,000 mPas, at from 20 mass % to not more than 60 mass % of component (A), and (A-2) an alkenyl-containing, resin-form organopolysiloxane that comprises the SiO_{4/2} unit, R¹₂R²SiO_{1/2} unit, and R¹₃SiO_{1/2} unit wherein R¹ is C₁₋₁₀ alkyl and R² is alkenyl, and that contains the alkenyl group in the range from at least 1 mass % A to less than 3.5 mass %, at from 40 mass % to not more than 80 mass % of component (A). The dialkylpolysiloxane (A1) has an average of at least two alkenyl groups in each molecule and a viscosity at 25° C. of 5000 to 1,000,000 mPas, at from 20 mass % to not more than 60 mass % of component (A).

Component (A-1) has an average of at least two alkenyl groups in each molecule. Component (A-1) has a substantially straight chain molecular structure, but a portion of the molecular chain may be somewhat branched. The alkenyl in component (A-1) can be exemplified by vinyl, allyl, isopropenyl, butenyl, hexenyl, and cyclohexenyl wherein vinyl is preferred. The bonding position for this alkenyl is not limited and may be, for example, the terminal position and/or side chain position on the molecular chain wherein terminal position on the molecular chain is preferred. The alkyl in component (A-1) can be exemplified by C₁₋₁₀ alkyl such as methyl, ethyl, propyl, cyclopentyl, cyclohexyl, and so forth, wherein methyl is preferred.

The viscosity of component (A-1) at 25° C. is in the range from 5,000 mPa·s to 1,000,000 mPa·s, alternatively in the range from 10,000 mPa·s to 500,000 mPa·s, alternatively in the range from 15,000 mPa·s to 200,000 mPa·s, alternatively in the range from >50,000 to 200,000 mPa·s. When component (A-1) is a mixture of two or more alkenyl-functional dialkylpolysiloxanes, the viscosity of this mixture at 25° C. must be in the alternate ranges described immediately above, (i.e., from 5,000 mPa·s to 1,000,000 mPa·s, alternatively 10,000 mPa·s to 500,000 mPa·s, alternatively 15,000 mPa·s to 200,000 mPa·s, alternatively >50,000 to 200,000 mPa·s). As long as the viscosity at 25° C. is in the specified range, component (A-1) may be a mixture of a small amount of an alkenyl-functional dialkylpolysiloxane gum and an alkenyl-functional dialkylpolysiloxane that is a liquid at 25° C. The reasons for the preceding are as follows: when the viscosity of component (A-1) at 25° C. is less than the lower limit cited above, the cured silicone material provided by the cure of the present composition tends to have an unsatisfactory flexibility; when, on the other hand, the viscosity of component (A-1) at 25° C. exceeds the upper limit cited above, the transparency of the cured silicone material provided by the cure of the present composition tends to decline at high temperatures, while the present composition assumes an excessively high viscosity and the handling characteristics tend to decline.

This component (A-1) diorganopolysiloxane is exemplified by dimethylpolysiloxanes endblocked at both molecular chain terminals by dimethylvinylsiloxy groups, dimethylsiloxane.methylvinylsiloxane copolymers endblocked at both molecular chain terminals by dimethylvinylsiloxy groups, methylvinylpolysiloxanes endblocked at both molecular chain terminals by trimethylsiloxy groups, dimethylsiloxane.methylvinylsiloxane copolymers endblocked at both molecular chain terminals by trimethylsiloxy groups, and mixtures of two or more of the preceding.

The content of component (A-1) in the present composition is an amount that is at least 20 mass % to not more than 60 mass % of component (A), alternatively an amount from at least 20 mass % to less than 50 mass % of component (A). The reasons for this are as follows: when the component (A-1) content is outside limits on the cited range, the flexibility and/or hardness of the cured silicone material provided by the cure of the present composition tends to decline, and the composition fouls molds too quickly during repeated curing of the composition in the same mold.

The alkenyl-containing, resin-form organopolysiloxane (A-2) imparts a satisfactory hardness and flexibility to the cured silicone material provided by the cure of the present composition and comprises the SiO_{4/2} unit, R¹₂R²SiO_{1/2} unit, and R¹₃SiO_{1/2} unit wherein R¹ is C₁₋₁₀ alkyl and R² is alkenyl, and that contains the alkenyl group in the range from at least 1 mass % to less than 3.5 mass %, at from 40 mass % to not more than 80 mass % of component (A). In these formulas, R¹ is C₁₋₁₀ alkyl such as methyl, ethyl, propyl, cyclopentyl, cyclohexyl, and so forth, and R² is an alkenyl group such as vinyl, allyl, isopropenyl, butenyl, hexenyl, cyclohexenyl, and so forth, wherein vinyl is preferred.

The component (A-2) alkenyl-containing, resin-form organopolysiloxane contains the alkenyl group at from at least 1 mass % to less than 3.5 mass %, alternatively contains from at least 1.0 mass % to not more than 2.5 mass % alkenyl. The reasons for this are as follows: when the alkenyl content in component (A-2) is less than the cited lower limit, the hardness of the cured silicone material provided by the cure of the present composition tends to decline; when, on the other hand, the alkenyl content in component (A-2) exceeds the cited upper limit, the flexibility of the cured silicone material provided by the cure of the present composition tends to decline and the transparency of the cured silicone material provided by the cure of the present composition tends to decline at high temperatures. Component (A-2) may be a mixture of two or more alkenyl-containing, resin-form organopolysiloxanes, in which case the mixture considered as such must contain alkenyl at from at least 1 mass % to less than 3.5 mass % and alternately contains from at least 1.0 mass % to not more than 2.5 mass % alkenyl.

The ratio of the total number of moles of R¹₂R²SiO_{1/2} and R¹₃SiO_{1/2} units to 1 mole of the SiO_{4/2} unit in component (A-2) is preferably in the range from 0.50 to 1.80 and particularly preferably is in the range from 0.70 to 1.10. The reasons for this are as follows: when the ratio of the total number of moles of R¹₂R²SiO_{1/2} and R¹₃SiO_{1/2} units to 1 mole of the SiO_{4/2} unit in component (A-2) is less than the cited lower limit, component (A-2) takes on an excessively large molecular weight and the transparency of the cured silicone material provided by the cure of the present composition may decline; when, on the other hand, the ratio of the total number of moles of R¹₂R²SiO_{1/2} and R¹₃SiO_{1/2} units to 1 mole of the SiO_{4/2} unit in component (A-2) exceeds the upper limit cited above, the cured silicone material provided by the cure of the present composition may have an unsatisfactory strength.

Component (A-2) has a mass-average molecular weight, on a standard polystyrene basis by gel permeation chromatography, preferably in the range from 3,000 to 7,000 and more preferably in the range from 4,000 to 6,000. Component (A-2) may be a mixture of two or more alkenyl-containing, resin-form organopolysiloxanes and is preferably a mixture comprising alkenyl-containing, resin-form organopolysiloxanes that have a mass-average molecular weight, on a standard polystyrene basis by gel permeation chromatography, in the range from 3,000 to 7,000.

The content of component (A-2) in the present composition is an amount that is at least 40 mass % to not more than 80 mass % of component (A), alternately is an amount that is greater than 50 mass % to not more than 80 mass % of component (A). The reasons for this are as follows: when the component (A-2) content is less than the lower limit on the cited range, the hardness of the cured silicone material provided by the cure of the present composition tends to decline; when, on the other hand, the component (A-2) content exceeds the upper limit on the cited range, the flexibility of the cured silicone material provided by the cure of the present composition tends to decline, the transparency of the cured silicone material provided by the cure of the present composition tends to decline at high temperatures, and the mold fouling rate increases.

The organopolysiloxane (B) has an average of at least three silicon-bonded hydrogen atoms in each molecule wherein the silicon-bonded groups other than the silicon-bonded hydrogen are C₁₋₁₀ alkyl, in an amount that provides 1.2 to less than 2.2 moles silicon-bonded hydrogen per 1 mole of the total alkenyl in component (A), wherein the organopolysiloxane (B) comprises (B-1) an organopolysiloxane that contains at least 0.7 mass % silicon-bonded hydrogen and that comprises SiO_{4/2} units and HR³₂SiO_{1/2} units in a ratio ranging from 1.50 to 2.50 moles of HR³₂SiO_{1/2} units per 1 mole of SiO_{4/2} units wherein R³ is C₁₋₁₀ alkyl, at 50 to 100 mass % of component (B), and (B-2) a straight-chain organopolysiloxane that contains at least 0.3 mass % silicon-bonded hydrogen wherein the silicon-bonded groups other than the silicon-bonded hydrogen are C₁₋₁₀ alkyl, at 0 to 50 mass % of component (B).

There are no limitations on the bonding position of the silicon-bonded hydrogen in component (B), and the silicon-bonded hydrogen may be bonded in, for example, terminal position on the molecular chain and/or side chain position on the molecular chain. The silicon-bonded groups in component (B) other than the silicon-bonded hydrogen are alkyl such as methyl, ethyl, propyl, cyclopentyl, cyclohexyl, and so forth, wherein methyl is preferred. This provides a good compatibility with component (A) and also provides an excellent transparency for the cured silicone material provided by the cure of the present composition. While there is no limitation on the viscosity of component (B), its viscosity at 25° C. is preferably in the range from 1 to 10,000 mm²/s and particularly preferably is in the range from 1 to 1,000 mm²/s.

In addition to the SiO_{4/2} unit and HR³₂SiO_{1/2} unit, component (B-1) may also contain the R³₃SiO_{1/2} unit. The ratio of the total number of moles of HR³₂SiO_{1/2} and R³₃SiO_{1/2} units to 1 mole of the SiO_{4/2} unit in component (B-1) is preferably in the range from 1.50 to 2.50 and more preferably is in the range from 1.80 to 2.20. A specific example of a preferred component (B-1) is the organopolysiloxane given by (SiO_{4/2})₄ (H(CH₃)₂SiO_{1/2})₈.

The straight-chain organopolysiloxane (B-2) contains at least 0.3 mass % and preferably at least 0.7 mass % silicon-bonded hydrogen. The silicon-bonded groups other than the silicon-bonded hydrogen are C₁₋₁₀ alkyl such as methyl, ethyl, propyl, cyclopentyl, cyclohexyl, and so forth, wherein methyl is preferred. Component (B-2) has a substantially straight chain molecular structure, but a portion of the molecular chain may be somewhat branched. Preferred specific examples of component (B-2) are dimethylsiloxane methylhydrogensiloxane copolymers endblocked at both molecular chain terminals by dimethylhydrogensiloxy groups, methylhydrogenpolysiloxanes endblocked at both molecular chain terminals by trimethylsiloxy groups, dimethylsiloxane.methylhydrogensiloxane copolymers endblocked at both molecular chain terminals by trimethylsiloxy groups, and mixtures of two or more of the preceding.

The content of component (B) in the present composition is an amount that provides 1.2 to less than 2.2, alternatively 1.2 to 2.1, alternatively 1.5 to 2.0, alternatively 1.6 to 1.9 moles of silicon-bonded hydrogen per 1 mole of the total alkenyl in component (A). The reasons for this are as follows: when the component (B) content is less than the lower limit for the cited range, curing of the composition tends to be unsatisfactory; when, on the other hand, the upper limit for the cited range is exceeded, the flexibility and/or transparency of the cured silicone material provided by the cure of the present composition may be diminished and mold fouling increased.

The hydrosilylation reaction catalyst that is component (C) is a catalyst for promoting curing of the present composition and can be exemplified by platinum-type catalysts, rhodium-type catalysts, and palladium-type catalysts, wherein the platinum-type catalysts are particularly preferred. These platinum-type catalysts can be exemplified by platinum micropowder, platinum black, platinum supported on silica micropowder, platinum supported on active carbon, chloroplatinic acid, alcohol solutions of chloroplatinic acid, and platinum compounds such as olefin complexes of platinum, alkenylsiloxane complexes of platinum, and so forth.

The component (C) content in the present composition is a catalytic quantity and in specific terms is a quantity that provides 0.01 to 1,000 mass-ppm, alternatively 0.01 to 10 mass-ppm, alternatively 0.01 to 9 mass-ppm, alternatively 1 to 7 mass-ppm, catalyst metal atoms with reference to the present composition. The reasons for this are as follows: when the component (C) content is less than the lower limit for the cited range, the risk arises that the cure of the resulting composition will not proceed adequately; on the other hand, by exceeding the upper limit for the cited range causes a decrease in optical clarity.

As other, optional components, the present composition may contain, for example, a reaction inhibitor in order to adjust the cure rate of the present composition, e.g., an alkyne alcohol such as 2-methyl-3-butyn-2-ol, 3,5-dimethyl-1-hexyn-3-ol, 1-ethynyl-1-cyclohexanol, phenylbutynol, and so forth; ene-yne compounds such as 3-methyl-3-penten-1-yne, 3,5-dimethyl-3-hexen-1-yne, and so forth; as well as 1,3,5,7-tetramethyl-1,3,5,7-tetravinylcyclotetrasiloxane, 1,3,5,7-tetramethyl-1,3,5,7-tetrahexenylcyclotetrasiloxane, benzotriazole, and so forth. There is no limitation on the content of this reaction inhibitor in the present composition, and this content may be selected as appropriate as a function of the molding method and curing conditions; however, an amount within the range from 10 to 5,000 mass-ppm with reference to the present composition is generally preferred.

The present composition may incorporate, insofar as the object of the present invention is not impaired, for example, an adhesion promoter, flame retardant, inorganic filler, and so forth. However, as a general matter, an adhesion promoter, flame retardant, and inorganic filler are preferably not incorporated from the perspective of the transparency of the cured silicone material provided by the cure of the present composition.

When the cured silicone material provided by the cure of the present composition is to be used in electrical.electronic applications, the content in the present composition of low molecular weight organopolysiloxane having a molecular weight not more than 650 is preferably not more than 350 ppm.

The viscosity of the present composition at 25° C. is not particularly limited, but considered from the standpoint of the moldability and handling characteristics, i.e., ease of pouring or injection, ease of degassing, and so forth, the viscosity of the present composition at 25° C. is preferably 1 to 100 Pa·s and particularly preferably is 2 to 50 Pa·s.

The present composition forms a cured silicone material when cured by heating to 100 to 250° C. This cured silicone material according to the present invention has a hardness, as measured using the type A durometer specified in JIS K 6253, in the range from at least 30 to not more than 80, preferably in the range from at least 50 to not more than 80, and more preferably in the range from at least 60 to not more than 75. The reasons for this are as follows: the cured silicone material may have insufficient strength when its hardness is less than the lower limit for the cited range; when, on the other hand, the upper limit for the cited range is exceeded, the flexibility of the cured silicone material under consideration tends to be inadequate. When this cured silicone material is to be used as an optical member or component, the hardness, as measured using the type A durometer specified in JIS K 6253, is particularly preferably in the range from at least 60 to not more than 80 based on a consideration of the moldability and the handling characteristics.

In order to exhibit a satisfactory flexibility, this cured silicone material must have an elongation as specified in JIS K 6251 of at least 50%. The reason for this is that the flexibility of the cured silicone material becomes unsatisfactory at below the indicated range.

The present cured silicone material must have a parallel light transmittance at 25° C., measured in accordance with JIS K 7105 on the 6 mm-thick cured silicone material, i.e., on a 6 mm optical path length, of at least 90%, and must have a parallel light transmittance at 200° C. that is a value that is at least 99% of the parallel light transmittance at 25° C. The reason for this is that deficiencies tend to occur in optical component applications when the present cured silicone material has a parallel light transmittance at 200° C. that is less than 99% of the parallel light transmittance at 25° C.

In addition, the present cured silicone material may be a composite in which the cured silicone material is formed into a single article with any of various substrates. The substrate can be exemplified by various metals, thermoplastic plastics, thermosetting plastics, rubbers such as silicone rubbers and so forth, backing fabrics such as those made of nylon or polyester, electronic parts and components, and light-emitting elements. Such a cured silicone composite can be obtained by coating the present composition on a substrate and then thermosetting.

A method of forming a highly transparent cured silicone material, the method comprising the following steps: heating a curable silicone composition comprising (A) 100 mass parts of an alkenyl-containing organopolysiloxane comprising
(A-1) a dialkylpolysiloxane that has an average of at least two alkenyl groups in each molecule and a viscosity at 25° C. of 5000 to 1,000,000 mPas, at from 20 mass % to not more than 60 mass % of component (A), and
(A-2) an alkenyl-containing, resin-form organopolysiloxane that comprises the SiO_{4/2} unit, R¹₂R²SiO_{1/2} unit, and R¹₃SiO_{1/2} unit wherein R¹ is C₁₋₁₀ alkyl and R² is alkenyl, and that contains the alkenyl group in the range from at least 1 mass % to less than 3.5 mass %, at from 40 mass % to not more than 80 mass % of component (A);
(B) an organopolysiloxane that has an average of at least three silicon-bonded hydrogen atoms in each molecule wherein the silicon-bonded groups other than the silicon-bonded hydrogen are C₁₋₁₀ alkyl, in an amount that provides 1.2 to less than 2.2 moles silicon-bonded hydrogen in this component per 1 mole of the total alkenyl in component (A), wherein component (B) is an organopolysiloxane comprising
   (B-1) an organopolysiloxane that contains at least 0.7 mass % silicon-bonded hydrogen and that comprises SiO_{4/2} units and HR³₂SiO_{1/2} units in a ratio ranging from 1.50 to 2.50 moles of HR³₂SiO_{1/2} units per 1 mole of SiO_{4/2} units wherein R³ is C₁₋₁₀ alkyl, at 50 to 100 mass % of component (B), and
   (B-2) a straight-chain organopolysiloxane that contains at least 0.3 mass % silicon-bonded hydrogen wherein the silicon-bonded groups other than the silicon-bonded hydrogen are C₁₋₁₀ alkyl, at 0 to 50 mass % of component (B); and
(C) a hydrosilylation reaction catalyst in a catalytic quantity at a temperature from 120 to 180° C. to form a cured silicone material.

The curable silicone composition of the method of forming a highly transparent cured silicone material is as described above for the curable silicone composition.

In one aspect of the invention, the method further comprises coating a mold with the curable silicone composition and heating the mold to cure the curable silicone composition. The mold may be coated by methods known in the art. For example, the mold may be coated by injecting the curable silicone composition into the mold. One skilled in the art would know how to coat a mold for curing a curable silicone composition. Heating may be accomplished by methods known in the art and one skilled in the art would know how to heat a mold to cure a curable silicone composition. The materials used for molds for molding curable silicone compositions are known in the art. One skilled in the art would know the materials to use in forming a mold for use in curing silicone compositions.

The curable silicone composition is heated at a temperature from 120 to 180° C., alternatively 130 to 170° C. The cured silicone material is as described above.

In one aspect of the invention, the method further comprises removing the cured silicone composition from the mold, recoating the mold with the curable silicone composition and curing the curable silicone composition on the recoated mold.

In another aspect of the invention, the mold is repeatedly recoated with the curable silicone composition and the curable silicone composition cured on the recoated mold over 500 times, alternatively over 1000 times, alternatively over 1500 times, alternatively over 2500 times without build-up of any silicon-based deposits on the mold requiring the mold be cleaned or replaced. Said differently, the mold may be used for 500 cycles, alternatively 100 cycles, alternatively 1500 cycles, alternatively 2500 cycles, where a cycle comprises coating the mold with the curable silicone composition, heating the curable silicone composition to cure the curable silicone composition to form a cured silicone material, and removal of the cured silicone material from the mold, with the proviso that the mold is not cleaned or replaced between cycles to remove silicon-based deposits from the mold. Silicon-based deposits in a mold are detected by examining the mold using a stereomicroscope with a magnification of 5×. The method of determining silicon deposits is described below in the examples.

In another aspect of the invention, the curable silicone composition has the proviso that there is less than 1%, alternatively less than 0.01%, alternatively no detectable level, based on the weight of the curable silicone composition of alkoxy.

The composition of the invention can be used repeatedly in molding processes with much reduced mold fouling. The method of the invention also results in reduced mold fouling compared to prior art compositions during repeated use in molding processes. As discussed above, mold fouling is where silicon-containing deposits build up on a mold during repeated use causing the quality of the molded article to reduce over repeated use of the mold. Mold fouling is observed in a mold under visual inspection using a stereoscope under 5× magnification.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention. All percentages are in wt. %. In the examples, the viscosity is the value at 25° C. and parts indicated mass parts.

TABLE 1
List of abbreviations used in the examples.

| Abbreviation | Word |
|---|---|
| g | gram |
| Me | methyl |
| wt | weight |
| % | percent |
| mol | mole |
| hr | hour |
| ° C. | degrees Celsius |
| NA | Not Applicable |
| mL | milliliters |
| Solids Content | (wt. of dried sample/wt. of initial sample) × 100 and |
| | determined as described below |
| cm | Centimeter |
| Vi | Vinyl Group |

Mold Fouling: Mold fouling was determined in the examples by visual inspection of the mold under 5× magnification using a stereoscope after every 100 cycles. Molded articles are placed in a one side entry black box in which uniform white light is introduced from the top. The visual inspection looks for deposits on the mold, which is mold fouling. Once silicon-containing deposits are observed, the number of cycles is noted. Pictures of the molded articles with the light diffusion are taken with a Nikon D5000 with DX 18-55 mm aperture.

The same mold was used for all examples. The mold was selected that is intricate in design as intricate molds are known to develop issues with mold fouling more quickly.

The nature and designation of the materials used in the following examples for components (A)-(C) and the reaction inhibitor as a cure retarder are as indicated below.

Component A-1

a-1: a dimethylpolysiloxane endblocked by dimethylvinylsiloxy groups at both molecular chain terminals, that has a viscosity (Mn) of 55,000 mPa·s and a vinyl group content of 0.09 mass %.

a-2: a dimethylpolysiloxane endblocked by dimethylvinylsiloxy groups at both molecular chain terminals, that has a viscosity of 9,000 mPa·s and a vinyl group content of 0.145 mass %.

Component A-2

a-3: an organopolysiloxane given by the average unit formula (ViMe₂SiO_{1/2})_{0.04} (Me₃SiO_{1/2})_{0.40}(SiO_{4/2})_{0.56}, that has a mass-average molecular weight (Mn) of approximately 37,000, a vinyl group content of 1.9 mass %, and a ratio of the total number of moles of R¹₂R²SiO_{1/2} and R¹₃SiO_{1/2} units to 1 mole of the SiO_{4/2} unit of 0.79.

Component B

b-1: an organopolysiloxane given by the average unit formula (HMe₂SiO_{1/2})₈(SiO_{4/2})₃, that has a kinematic viscosity of 23 mm²/s and a silicon-bonded hydrogen atom content of approximately 0.96 mass %.

Component C

Platinum catalyst: a 1,3-divinyltetramethyldisiloxane solution of a 1,3-divinyltetramethyldisiloxane complex of platinum. The platinum metal content is approximately 6500 ppm.

Component D: Reaction Inhibitor as a Cure Retarder

### 3,5-dimethyl-1-octyn-3-ol

| | | Composition in Parts | | | |
|---|---|---|---|---|---|
| | | | | | Comparative |
| Component | Description | Example 1 | Example 2 | Example 3 | Example 1 |
| A-1 (a-1) | Siloxane Polymer | 5.14 | 5.05 | 5.09 | 5.19 |
| A-1 (a- 2) | Siloxane Polymer | 41.64 | 41.25 | 41.25 | 42.06 |
| A-2 (a-3) | Siloxane Resin | 48.16 | 47.59 | 47.71 | 48.64 |
| B (b-1) | Cross Linker | 4.60 | 5.60 | 5.60 | 3.68 |
| C | Hydrosilylation Catalyst | 0.06 | 0.12 | 0.06 | 0.16 |
| D | Inhibitor | 0.20 | 0.20 | 0.10 | 0.07 |

| | | | | |
|---|---|---|---|---|
| SiH:Vi Ratio | 1.40 | 1.72 | 1.76 | 1.12 |
| Catalyst ppm | 3.1 | 6.2 | 3.1 | 3.7 |
| Molding cycles w/o visible fouling | 2000 | >10,000 | >10,000 | <1000 |

In Example 1, the curable composition of Example 1 was injected into a mold to coat the mold, and then the curable composition was cured to form a cured composition/article at a mold temperature of around 150° C. and for a specific time sufficient to cure the curable composition in the mold but not to scorch the curable composition. After curing, a robot removed the cured composition from the mold and the mold was recoated with the curable composition of Example 1 again by injection molding, the curable composition recoated on the mold was cured, and the cured composition/article removed again by a robot from the mold. This process of coating the mold, curing, and removing the cured article was repeated up to 10,000 times or until mold fouling was detected. The mold was inspected after every 100 cycles of injection, cure, and removal of the cured composition/article for mold fouling. The mold was inspected for mold fouling using a 5× magnification stereoscope, black box, and Nikon camera as described above. The curable composition of Example 1 was coated onto the mold and cured two thousand times before mold fouling (i.e., deposits) was observed on the mold. Examples 2-3 and Comparative example 1 used the same mold, mold temperature, cure time, cured article/composition removal process, coating process (injection), and mold fouling observation process as Example 1. The number of cycles each for the compositions of Examples 2-3 and Comparative Example 1 before mold fouling was observed are listed in the table. The examples show that the compositions according the invention can be cured in a mold over two thousand times without fouling the mold, but the composition of Comparative Example 1 fouled the mold after less than one thousand cycles.

1. A curable silicone composition comprising
(A) 100 mass parts of an alkenyl-containing organopolysiloxane comprising
(A-1) a dialkylpolysiloxane that has an average of at least two alkenyl groups in each molecule and a viscosity at 25° C. of 5000 to 1,000,000 mPas, at from 20 mass % to not more than 60 mass % of component (A), and
(A-2) an alkenyl-containing, resin-form organopolysiloxane that comprises an SiO_{4/2} unit, R¹₂R²SiO_{1/2} unit, and R¹₃SiO_{1/2} unit wherein R¹ is C₁₋₁₀ alkyl and R² is alkenyl, and that contains the alkenyl group in the range from at least 1 mass % to less than 3.5 mass %, at from 40 mass % to not more than 80 mass % of component (A);
(B) an organopolysiloxane that has an average of at least three silicon-bonded hydrogen atoms in each molecule wherein the silicon-bonded groups other than the silicon-bonded hydrogen are C₁₋₁₀ alkyl, in an amount that provides 1.2 to less than 2.2 moles silicon-bonded hydrogen in this component (B) per 1 mole of the total alkenyl in component (A),
and contains at least 0.7 mass % silicon-bonded hydrogen and that comprises SiO_{4/2} units and HR³₂SiO_{1/2} units in a ratio ranging from 1.50 to 2.50 moles of HR³₂SiO_{1/2} units per 1 mole of SiO_{4/2} units wherein R³ is C₁₋₁₀ alkyl; and
(C) a hydrosilylation reaction catalyst in a catalytic quantity.

2. A cured silicone material provided by curing the curable silicone composition according to claim 1, wherein a parallel light transmittance at 25° C. measured in accordance with JIS K 7105 on 6 mm optical path length is at least 90%.

3. The cured silicone material according to claim 2, which has a hardness measured using the type A durometer as specified in JIS K 6253 in the range from at least 30 to not more than 90, an elongation as specified in JIS K 6251 of at least 50%, and the parallel light transmittance at 200° C. of a value that is at least 99% of the parallel light transmittance at 25° C.

4. The cured silicone material according to claim 2, wherein curing is performed at a temperature from 120 to 180° C.

5. The cured silicone material according to claim 2, wherein the cured silicone material is in a form of a cured silicone layer, such cured silicone layer and a substrate forms a single article, and wherein the cured silicone layer is formed on the substrate by heating to cure the curable silicone composition according to claim 1 at a temperature from 120 to 180° C.

6. The cured silicone material according to claim 2, which has a hardness measured using the type A durometer as specified in JIS K 6253 in the range from at least 50 to not more than 90.

7. The curable silicone composition according to claim 1, wherein (B) is in an amount that provides 1.5-2.0 moles silicon-bonded hydrogen per 1 mole of the total alkenyl in component (A).

8. The curable silicone composition according to claim 1, further comprising an additional ingredient selected from the group consisting of: an inhibitor, a mold release agent, a filler, an adhesion promoter, a heat stabilizer, a flame retardant, a reactive diluent, an oxidation inhibitor, and a combination of any two or more thereof.

9. The curable silicone composition according to claim 1, wherein the dialkylpolysiloxane (A-1) has a viscosity at 25° C. of 10,000 to 500,000 mPas.

10. A method of forming a cured silicone material, the method comprising the step of heating a curable silicone composition comprising (A) 100 mass parts of an alkenyl-containing organopolysiloxane comprising
(A-1) a dialkylpolysiloxane that has an average of at least two alkenyl groups in each molecule and a viscosity at 25° C. of 5000 to 1,000,000 mPas, at from 20 mass % to not more than 60 mass % of component (A), and
(A-2) an alkenyl-containing, resin-form organopolysiloxane that comprises the SiO_{4/2} unit, R¹₂SiO_{1/2} unit, and R¹₃SiO_{1/2} unit wherein R¹ is C₁₋₁₀ alkyl and R² is alkenyl, and that contains the alkenyl group in the range from at least 1 mass % to less than 3.5 mass %, at from 40 mass % to not more than 80 mass % of component (A);
(B) an organopolysiloxane that has an average of at least three silicon-bonded hydrogen atoms in each molecule wherein the silicon-bonded groups other than the silicon-bonded hydrogen are C₁₋₁₀ alkyl, in an amount that provides 1.2 to less than 2.2 moles silicon-bonded hydrogen in this component per 1 mole of the total alkenyl in component (A),
and that contains at least 0.7 mass % silicon-bonded hydrogen and that comprises SiO_{4/2} units and HR³₂SiO_{1/2} units in a ratio ranging from 1.50 to 2.50 moles of HR³₂SiO_{1/2} units per 1 mole of SiO_{4/2} units wherein R³ is C₁₋₁₀ alkyl, and
(B-2) a straight-chain organopolysiloxane that contains at least 0.3 mass % silicon-bonded hydrogen wherein the silicon-bonded groups other than the silicon-bonded hydrogen are C₁₋₁₀ alkyl, at 0 to 50 mass % of component (B); and
(C) a hydrosilylation reaction catalyst in a catalytic quantity
at a temperature from 120 to 180° C. to form a cured silicone material.

11. The method of claim 10 further comprising the step of coating a mold with the curable silicone composition of claim 1, wherein heating is done by heating the mold to cure the curable silicone composition.

12. The method of claim 11 further comprising the steps of removing the cured silicone composition from the mold, recoating the mold with the curable silicone composition without cleaning the mold, and curing the curable silicone composition to form a cured silicone material.

13. The method of claim 12, wherein the sequentially repeated over 1000 times before the mold is cleaned or replaced.

14. The method according to claim 10 wherein, prior to the heating step, further comprising the step of coating a substrate with the curable silicone composition so that the cured silicone material is a cured silicone layer that, together with the substrate, forms a single article.
